(19) United States
(12) Patent Application Publication
(10) Pub. No.: US 2025/0231563 A1
(43) Pub. Date: Jul. 17, 2025

(54) Method for Ascertaining the Position of a Transport Means of a Conveyor System, and Conveyor System

(71) Applicant: Bayerische Motoren Werke Aktiengesellschaft, Muenchen (DE)

(72) Inventors: Ulrich KRAUSE, Leipzig (DE); Sebastian SCHAUER, Leipzig (DE)

(21) Appl. No.: 18/854,724

(22) PCT Filed: Mar. 28, 2023
(86) PCT No.: PCT/EP2023/057920

§ 371 Date: Oct. 7, 2024

(30) Foreign Application Priority Data
Apr. 8, 2022 (DE) 10 2022 108 532.5

(51) Int. Cl. G05D 1/244; B61L 25/02; G05D 101/00; G05D 107/70

(52) U.S. Cl. CPC G05D 1/2446; B61L 25/025; G05D 2101/22; G05D 2107/70

(57) ABSTRACT

A method for ascertaining a position of at least one transport apparatus includes the step of capturing and ascertaining. The transport apparatus is configured to transport at least one component of a conveyor system. The step of capturing includes capturing at least one marking arranged in an area of a travel path, along which the transport apparatus travels through at least one route section, with an optical capture device of the transport apparatus. The step of ascertaining includes ascertaining a multidimensional position of the transport apparatus in the space with an electronic computing device, as a function of the captured marking.

### BACKGROUND AND SUMMARY

The disclosure relates to a method for ascertaining a position of at least one transport means, intended for transporting at least one component, of a conveyor system according to the disclosure. Furthermore, the disclosure relates to a conveyor system for transporting at least one component according to the disclosure.

EP 3 036 184 B1 discloses a coding device for marking positions in an elevator shaft and for determining the position of elevator cars in the elevator shaft, which comprises a code band, wherein the code band has at least three markings, which are arranged along the length of the code band in order to each mark discrete positions.

It is an object of the disclosure to provide a method for ascertaining a position of at least one transport means, intended for transporting at least one component, of a conveyor system, and a conveyor system for transporting at least one component, so that the position of the transport means can be ascertained with particularly little effort and particularly precisely.

This object is achieved according to the disclosure by a method for ascertaining a position of at least one transport means, intended for transporting at least one component, of a conveyor system having the features of claim 1 and by a conveyor system for transporting at least one component having the features of claim 8. Advantageous embodiments of the disclosure are the subject matter of the dependent claims and the description.

A first aspect of the disclosure relates to a method for ascertaining a position, in particular a current position, of at least one transport means, intended for transporting at least one component, of a conveyor system. This means that in operation of the conveyor system or in a method for operating the conveyor system, at least one component is transported using at least one transport means of the conveyor system. This can be understood in particular to mean that a respective component arranged at or on the transport means can be conveyed or transported by means of the transport means from a first location to a second location at a distance from the first location. The conveyor system can be designated in particular as a conveyor technology system.

The conveyor system preferably comprises multiple transport means. For example, the respective transport means is designed as a vehicle, in particular as a hanger. This means that the conveyor system can be designed in particular as a monorail system, in particular as an electrified monorail system (EMS). Alternatively, the conveyor system can be designed, for example, as a skillet conveyor system. This means that the respective transport means can be designed as a respective skillet conveyor, which is in particular rail-bound.

The conveyor system or the respective transport means is preferably intended, in particular exclusively, for transporting components or objects. This means that the conveyor system or the respective transport means is preferably not intended for conveying persons.

The component is, for example, a component or an assembly of a motor vehicle or for a motor vehicle. For example, the component is a motor vehicle which may be in its completely produced state or which may not be in its completely produced state. The motor vehicle is preferably designed as an automobile, in particular as a passenger vehicle, utility vehicle, or as a truck. The assembly can be understood in particular as an assemblage.

The conveyor system is intended, for example, for motor vehicle production. This means that the respective component can be transported by means of the respective transport means to a manufacturing plant, by means of which, in particular by means of the respective components, the motor vehicle or motor vehicles are producible. Alternatively, the conveyor system can be, for example, part of the manufacturing plant. This means that the respective components can be transported, for example, by means of the conveyor system or by means of the respective transport means within the manufacturing plant, for example, for installation. For example, the conveyor system can be provided for door assembly during motor vehicle production. This means that the respective component or the respective assembly can be in particular a door of the motor vehicle designated as a vehicle door, which can be assembled or attached, for example, in particular in the manufacturing plant, on or to the motor vehicle, in particular on or to a body of the motor vehicle. Alternatively, the respective doors can be preassembled during the door assembly. This means that the respective doors can be brought, for example, by assembly, i.e., by attaching at least one element, from a not completely produced state into a completely produced state. Alternatively, the conveyor system can be provided, for example, for a rack, in particular a high rack.

In the method, it is provided that at least one, in particular optical, marking, which is arranged in the area of a travel path along which the transport means travels through at least one route section, in particular of the conveyor system, is captured by means of an optical capture device of the transport means. In other words, the transport means is moved along the travel path through the conveyor system, in particular through the route section, wherein the at least one, in particular optical, marking is arranged at least close to the travel path, in particular on or in the travel path, which marking is detected by means of the optical capture device of the transport means. For example, at least one variable characterizing the marking is captured by means of the optical capture device, in particular upon the capture of the marking. The variable characterizing the marking can be understood in particular as information characterizing the marking. It is preferably provided that a large number of, in particular optical, markings are arranged in the area of the travel path.

The travel path can be understood in particular as a travel route on or in which the transport means travels through or traverses the conveyor system or the route section. The travel path can therefore be understood in particular as a track.

To be able to ascertain the position of the transport means with particularly little effort and particularly precisely, it is provided according to the disclosure that a multidimensional, in particular two-dimensional or three-dimensional position, which is in particular current, of the transport means in the space, in particular in the conveyor system, is ascertained or calculated by means of an electronic computing device as a function of the captured marking. In other words, the variable characterizing the marking is used as an input variable, by means of which the, in particular current, multidimensional position of the transport means is ascertained or calculated as an output variable by means of the electronic computing device. This means that the multidimensional position is ascertained or calculated by means of the electronic computing device as a function of the variable characterizing the marking.

The ascertainment of the multidimensional, in particular current, position in the space can therefore be understood in particular as a localization, in particular real-time localization of the transport means. A localization system, in particular a real-time localization system, can therefore be provided for locating the transport means, wherein the localization system in particular comprises the electronic computing device.

The current, in particular multidimensional, position can be understood in particular to mean that the ascertained, in particular multidimensional, position is a position which the transport means occupies in the space upon the capture or during the capture of the marking by means of the optical capture device.

The multidimensional position of the transport means in the space can be understood in particular as a multidimensional position of the transport means in the conveyor system, in particular in the manufacturing plant. This means that the multidimensional position is not a position, in particular not a one-dimensional position, related to the travel path. The, in particular one-dimensional, position of the transport means on the travel path can be understood in particular as a position which relates to a starting point arranged in the travel path and a destination point arranged in the travel path. This means that the, in particular one-dimensional, position on the travel path can be understood in particular as a position which relates to path coordinates or route coordinates of the travel path. In contrast, the multidimensional position of the transport means in the space relates to spatial coordinates, which are in particular independent of the travel path, of the conveyor system, in particular of the manufacturing plant. A coordinate origin of a coordinate system for describing the multidimensional position of the transport means in the space is therefore preferably independent of the travel path or is at a distance from the travel path. In contrast, a coordinate origin of a coordinate system for describing the, in particular one-dimensional, position of the transport means on the travel path is preferably arranged in the travel path. This means that the multidimensional position of the transport means in the space can be understood in particular as a multidimensional position of the transport means in relation to an environment of the travel path, in particular to an environment of the conveyor system.

For example, in the method, in particular by the capture of the marking by means of the optical capture device, the multidimensional position of the transport means in the space can be ascertained by means of the electronic computing device from the one-dimensional position of the transport means in the travel path. This means that a translation of the one-dimensional position of the transport means in the travel path to the multidimensional position of the transport means in the space can be carried out, in particular for positioning the transport means, for example the respective motor vehicle, within the conveyor system or the manufacturing plant.

The electronic computing device can be part of the conveyor system or the electronic computing device can be designed separately from the conveyor system. The electronic computing device designed separately from the conveyor system can be designated in particular as an external electronic computing device. For example, the electronic computing device is an electronic data processing system, in particular a computer.

The conveyor system can have at least one second electronic computing device, which is in particular designed separately from the electronic computing device and by means of which the conveyor system is controllable. This means that the conveyor system, in particular the at least one transport means, can be monitored and/or controlled by means of the second electronic computing device. For example, the second electronic computing device is designed as a programmable logic controller (PLC). Alternatively, the second electronic computing device can be designed, for example, as a radio-frequency identification reader (RFID reader). The second electronic computing device is preferably designed separately from the transport means. Alternatively, the transport means can comprise the second electronic computing device. For example, the variable characterizing the marking is ascertained by means of the second electronic computing device as a function of the marking captured by means of the optical capture device. Alternatively, the variable characterizing the marking can be ascertained by means of the optical capture device and transmitted to the second electronic computing device.

The variable characterizing the marking is preferably transmitted from the second electronic computing device to the electronic computing device, which is in particular designated as the first electronic computing device, wherein the multidimensional position of the transport means in the space is ascertained by means of the first electronic computing device as a function of the transmitted variable characterizing the marking. This means that the electronic computing device can retrieve data, in particular automatically, in particular in the form of the variable characterizing the marking, from the second electronic computing device and can calculate the multidimensional, in particular three-dimensional, position of the transport means in the space therefrom, in particular automatically.

The disclosure is based in particular on the following findings and considerations: As a function of the ascertained multidimensional position of the transport means in the space, the transportation of the at least one component and/or the motor vehicle production can be influenced, in particular particularly advantageously. In particular during the production of motor vehicles it can be particularly useful to know a respective location of objects in the production environment. This applies in particular to the assembly. An efficiency increase in the production can be achieved in the assembly by a real-time localization system. For example, a third electronic computing device, which is in particular designed separately from the first and/or second electronic computing device, can be provided, which can be designated in particular as an IPS-i. The influencing of the transportation or the motor vehicle production can be carried out by means of the third electronic computing device. This means that the multidimensional position of the transport means in the space can be transmitted from the first electronic computing device, in particular for processing, to the third electronic computing device.

In a conventional method, the multidimensional position of the transport means in the space can be ascertained, for example, by means of radio localization via triangulation, in particular via real-time location service (RTLS). For this purpose, the transport means can have a tag, designated in particular as a localization tag, which is provided for localization. Alternatively, the tag can be arranged on the respective component or on the respective motor vehicle to be assembled. A use of radio triangulation can typically be accompanied by several obvious disadvantages. On the one hand, an accuracy of the localization of the respective transport means can be limited or can be particularly low. The accuracy can be, for example, ±30 cm. Furthermore, the localization by means of radio triangulation can be particularly susceptible to interference, in particular with respect to metal and/or water. This means that the accuracy can be negatively influenced by the presence of metal and/or water in the triangulation area. This means that the localization by means of radio triangulation can be interfered with in particular by the presence of persons, in particular designated as employees. Moreover, with radio triangulation, the ascertained multidimensional position can typically only be an item of two-dimensional information. This means that items of height information can only be taken into consideration with particular expenditure, in particular particularly expensively. For example, antennas on two levels can be required for this purpose. Moreover, the use of radio triangulation or radio triangulation system is particularly costly, in particular in the construction. This can be the case, for example, in that particularly costly antenna systems are to be provided or constructed.

Furthermore, it can be provided during the assembly, for example, that the tag is removed from the transport means or the motor vehicle or the component, due to which localization by means of radio triangulation is no longer possible. Furthermore, in radio localization by means of triangulation, it can typically be necessary to provide a location coverage, which is in particular complete, via radio. This is typically particularly complex. Furthermore, particularly many antennas typically have to be installed in the production areas for radio localization, which can mean a particularly high financial expenditure. Alternatively, it would be conceivable to locate the respective motor vehicle by means of the GPS module installed in the motor vehicle. However, it is necessary for this purpose that the GPS module is already installed in the motor vehicle. This means that it may not be possible to locate the motor vehicle by means of GPS in the non-completely produced state of the motor vehicle. The localization via GPS thus typically cannot be used during the assembly. Furthermore, the localization via GPS can be disadvantageous or not useful in a building, in particular in a manufacturing hall or in an assembly hall.

In contrast, the multidimensional position of the transport means can be ascertained with particularly little effort and particularly precisely by means of the method according to the disclosure. For example, in the method according to the disclosure, the particularly complex or particularly expensive location coverage, in particular the antennas, can be omitted. In particular costs or production expenditure of the motor vehicles can thus be kept particularly low. For example, the accuracy of the multidimensional positions ascertained by means of the method according to the disclosure is ±10%. The multidimensional positions can thus be ascertained particularly accurately, in particular more accurately than by means of a conventional method, for example by means of radio triangulation. This can be achieved, for example, in that the method according to the disclosure has a particularly high level of safety with respect to errors and is therefore in particular less susceptible to errors or interference than radio triangulation. This is the case, for example, because no interfering influence is provided with respect to water or metal. Furthermore, the conveyor system operated by means of the method according to the disclosure requires particularly little maintenance and is linked with particularly low costs both in production and in operation. The multidimensional positions ascertained by means of the method according to the disclosure can be particularly good both with respect to a quality of supplied data and also with respect to an abundance of the supplied data, in particular better than with radio triangulation.

Furthermore, the motor vehicle production can particularly be improved by means of the method according to the disclosure. A quality of the produced vehicles can particularly be increased, for example, while a production expenditure of the produced motor vehicles can be kept particularly low at the same time. For example, in particular by means of the third electronic computing device, for example during the assembly, it can be displayed or signaled to the employee or the person by means of at least one, in particular optical and/or acoustic, display device when in their cycle a motor vehicle having particularly rare equipment is approaching. The person can thus be warned, by which a possible number of errors can be minimized or kept particularly low. The quality of the produced motor vehicle can thus be increased in particular. The display device can be designed, for example, as a smartwatch, on which an alarm intended for the respective employee can be triggered. This can be designated in particular as an exotic alarm.

Alternatively or additionally, assembly processes, in particular critical screwing processes, can be automated, documented, and controlled by means of the method according to the disclosure. For example, when a screwing device approaches a specific point of the component or the motor vehicle, in particular as a function of the ascertained three-dimensional position, for example in a semiautomated or fully automated manner, proper screwing can be carried out and this can be established, for example in a database, in particular without an employer having to scan a routing slip or manually document the screwing action in another way, for example. This can be designated in particular as WAS. The quality of the produced motor vehicle can thus be increased in particular. For example, during the assembly, an element, in particular designed separately from the component, can be attached or fastened in particular automatically on the component, in particular on the motor vehicle, for example on the vehicle body, when a first value of the multidimensional position of the transport means in the space is ascertained by means of the electronic computing device, wherein the attachment of the element does not take place when a second value of the multidimensional position of the transport means in the space, which is different from the first value, is ascertained by means of the electronic computing device.

In particular when the screwing device is freely movable, in particular in the space, a localization of a position of the screwing device in the space can be provided, for example by means of radio localization.

Alternatively or additionally, for example, during the assembly, in particular as a function of the multidimensional ascertained position, items of assembly information, in particular elements to be installed and/or special features of the motor vehicle, for example right-hand drive, can be displayed on at least one display screen with reference to a type of an approaching motor vehicle. This can be designated in particular as a design variant information system (DVIS). The motor vehicles can thus be produced with particularly low effort. Moreover, the quality of the produced motor vehicles can thus be increased in particular.

For example, the conveyor system, in particular the manufacturing plant, can have at least one second optical capture device, in particular designed separately from the optical capture device. The second optical capture device is designed, for example, as a scanner or as a camera. The second optical capture device is designed, for example, to read a QR code or record an image when the transport means or the motor vehicle is located at a specific point in the conveyor system or the manufacturing plant. This means that, for example, by means of the second optical capture device, the image is recorded or the QR code is read when the first value is ascertained and the recording of the image or the reading of the QR code does not take place when the second value is ascertained. As a function of the recorded image or the read QR code, for example, at least one variable characterizing a quality of the motor vehicle can be ascertained, in particular in an automated manner. This can be designated in particular as an artificial intelligence quality next (AIQX). The quality of the produced motor vehicles can thus be increased in particular.

Alternatively or additionally, a level of safety of the conveyor system, in particular a level of safety during the motor vehicle production, can be increased in particular by means of the method according to the disclosure. It can be detected, for example, as a function of the multidimensional position ascertained by means of the electronic computing device whether the transport means is located in a defined area, is leaving this area, or is entering this area. A level of safety for at least one person located in the defined area can thus be increased in particular, for example. Furthermore, for example, as a function of the ascertained three-dimensional position, an imminent collision of transport means, in particular if a distance between the transport means falls below a predefined minimum distance, can be detected or predicted. The collision can thus be prevented, by which, for example, the level of safety of the conveyor system can be increased in particular. Moreover, a production failure can thus also be avoided, due to which in particular production costs of the motor vehicles can be kept particularly low. Alternatively, for example, a collision of the transport means with a screwing device, which can be guided, for example, by the employee to the transport means, can be detected.

For example, the second optical detection device, in particular the camera, can have difficulties during capturing, in particular during focusing, if a distance to the target object can only be ascertained particularly inaccurately and therefore can vary up to 60 cm, for example. The second optical capture device, in particular the camera, therefore cannot be used, for example, in the conventional method, in particular in the triangulation, or a quality of the capture can be particularly inadequate. Since the accuracy of the position ascertainment can be increased in particular by means of the method according to the disclosure, in particular in relation to radio triangulation, the second optical capture device, in particular the camera, can be used by means of the method according to the disclosure.

The method according to the disclosure can be used, for example, as an alternative to radio triangulation. Alternatively, it is possible to use the method according to the disclosure in addition to radio triangulation. A reliability of the ascertainment of the multidimensional positions can thus be increased in particular. The method according to the disclosure can therefore be used, for example, as a backup solution for radio triangulation. Of course, radio triangulation can alternatively be used as a backup solution for the method according to the disclosure. Alternatively or additionally, for example, a mixed operation made up of the radio triangulation and the method according to the disclosure can be carried out, in which, for example, a tool, in particular a screwing tool, or another object, which is mobile in particular, different from the respective transport means is located by means of radio triangulation. Screwing systems, which are mobile in particular, or other mobile applications can thus be operated or carried out particularly advantageously, for example.

It is preferably provided that at least one barcode arranged in the area of the travel path is captured by means of the optical capture device of the transport means as the at least one marking. In other words, the, in particular optical, marking is designed as a barcode. This means that the variable characterizing the marking can be designated in particular as the variable characterizing the barcode. The multidimensional position of the transport means in the space can thus be ascertained particularly precisely. This can be achieved, for example, in that the barcode can be captured particularly precisely by means of the optical capture device. Furthermore, the barcode can be captured with particularly little effort by means of the optical capture device, due to which the multidimensional position of the transport means in the space can be ascertained with particularly little effort. In particular, the capture of the barcode by means of the optical capture device can take place particularly reliably.

The barcode can be understood in particular as a bar code, which can be designated in particular as a barred code or as a stripe code. Furthermore, the barcode can be understood as an optoelectronically readable script, which comprises parallel stripes and gaps of different widths. The optical marking designed as a barcode preferably extends in two spatial dimensions, wherein a first extension along a first spatial dimension is preferably greater than a second extension in a second spatial dimension different from the first spatial dimension. The barcode can thus be understood in particular as a 2D code. The barcode is designed, for example, as a code band, in particular as an endless barcode. This means that a large number of barcodes are arranged one behind another or adjacent to one another in the area of the travel path, for example, which form the endless barcode. The respective barcodes can be spaced apart from one another, in particular in the longitudinal extension direction of the travel path. Distances between each two adjacent barcodes can each be constant.

It is preferably provided that the marking, in particular the barcode, is captured by means of the optical capture device while the transport means travels through the conveyor system, in particular the route section or the space. In other words, the transport means moves relative to the travel path or a part of the conveyor system forming or delimiting the travel path upon or during the capture of the marking. This means that the transport means is not at rest while the marking or the barcode is captured by means of the optical capture device. Because the capture of the marking is possible during the travel through the conveyor system, the method or the conveyor system can particularly advantageously be used for the assembly or assembly processes.

In a further embodiment, it is provided that the multidimensional position of the transport means in the space is ascertained or calculated by means of the electronic computing device as a function of at least one multidimensional, in particular two-dimensional or three-dimensional, reference position, which is assigned to at least one reference point of the travel path, of the reference point in the space, in particular in the conveyor system or the manufacturing plant, and in particular as a function of the captured marking. In other words, the multidimensional reference position of the reference point and the variable characterizing the optical marking are used as input variables, by means of which the multidimensional position of the transport means in the space is ascertained or calculated as an output variable. The multidimensional position of the transport means in the space can thus be ascertained with particularly little effort and particularly precisely. For example, the multidimensional reference position of the reference point is stored in a memory of the electronic computing device or in a memory of the second electronic computing device or in a database designed separately from the electronic computing devices. This means that the multidimensional reference position is already known, due to which the multidimensional position of the transport means in the space can be ascertained with particularly little effort as a function of the multidimensional reference position. In particular, a computing time for ascertaining the multidimensional position of the transport means in the space can be kept particularly short, in particular in that, for example, a number of computing operations to be carried out by means of the electronic computing device can be kept particularly low.

The reference point can be understood in particular as an, in particular optical, reference marking. The reference marking is preferably arranged in the area of the travel path, in particular at or in the travel path. The reference marking is preferably designed as a barcode, which can be designated in particular as a reference barcode.

For example, it is provided that the at least one reference marking, in particular the reference barcode, arranged in the area of the travel path is captured by means of the optical capture device, wherein the multidimensional position of the transport means in the space is ascertained by means of the electronic computing device as a function of the multidimensional reference position, assigned to the reference marking, of the reference marking in the space, and in particular as a function of the captured marking.

In a further embodiment, it is provided that a distance to be covered, in particular a distance which has been covered, by the transport means on the travel path between the captured marking and the at least one reference point, in particular the reference marking, is ascertained or calculated by means of the electronic computing device as a function of the captured marking, and in particular as a function of the captured reference marking, as a function of which distance the multidimensional position of the transport means in the space is ascertained or calculated by means of the electronic computing device. In other words, by means of the electronic computing device, the distance which is to be covered or has been covered by the transport means on the travel path between the captured marking and the at least one reference point is ascertained by means of the electronic computing device, which distance is used as the input variable, by means of which the multidimensional position of the transport means in the space is ascertained or calculated as an output variable by means of the electronic computing device. The multidimensional position of the transport means in the space can thus be ascertained with particularly little effort and particularly precisely.

The distance can be understood in particular as a travel route which is to be overcome by the transport means in order to move from the reference point or the reference marking along the travel path to the captured marking. The transport means thus covers the distance when the transport means, in particular starting from the reference point or the reference marking, is moved on the travel route or along the travel path to the marking.

For example, it is provided that the multidimensional position of the transport means in the space is ascertained or calculated by means of the electronic computing device as a function of a ratio, ascertained as a function of the captured marking, between a route of a route section of a portion of the travel path, which is already covered by the transport means upon capture of the marking, and a total length of the portion. This means that as a function of a fraction of a distance already covered on the portion by the transport means upon the capture or during the capture of the marking to the total length of the portion, the multidimensional position of the transport means in the space is ascertained. The multidimensional position of the transport means in the space can thus be ascertained with particularly little effort and particularly precisely. It can be provided that the ratio or the fraction is ascertained in the method. This means that the ratio between the route of the portion of the travel path covered by the transport means upon the capture of the marking and the total length of the portion is ascertained by means of the electronic computing device as a function of the captured marking, and the multidimensional position of the transport means in the space is ascertained or calculated as a function of the ascertained ratio, and in particular as a function of the reference position.

The portion can be understood in particular as a segment of the travel path, in particular designated as a partial segment. The segment has the total length. The total length can be understood in particular as a distance or a route which is to be covered by the transport means in order to travel through the portion, in particular completely, i.e. in particular to move from an entry area of the portion to an exit area of the portion. The entry area of the portion can be understood in particular as a beginning of the portion.

The exit area of the portion can be understood in particular as an end of the portion. This means that when the transport means is moved from the beginning of the portion along the travel path to the end of the portion, the transport means covers the entire length of the route or the portion. Furthermore, the route of the portion can be understood in particular as a fraction of the total length of the portion and thus in particular as a partial route of the portion.

For example, it is provided that at least one variable characterizing the reference marking is captured by means of the optical capture device, wherein the multidimensional reference position of the reference marking is ascertained by means of the electronic computing device as a function of the variable characterizing the reference marking. The multidimensional reference position can be retrieved from the memory or from the database.

It is preferably provided that the travel path comprises multiple portions, in particular a large number of portions. This means that the travel path can be divided into multiple segments, in particular a large number of segments. The segments adjoin one another, in particular directly. At least one, in particular optical marking, in particular multiple markings, which are designed in particular as barcodes, is preferably arranged in each case in the area of the respective portion, in particular at or in the respective portion. At least one, in particular optical, reference marking, in particular two reference markings, is preferably arranged in the area of the respective portion, in particular at or in the respective portion. For example, a first of the reference markings is arranged in each case at the beginning of the respective portion. For example, the second of the reference markings is arranged in each case at the end of the respective portion. This means that the optical markings assigned to the respective portion are arranged in the area of the travel path between the reference markings. A respective number of the markings assigned to the respective portion and respective distances between the markings assigned to the respective portion are known, and in particular stored in the memory, in particular in the memory of the first or second electronic computing device or the database. If one of these markings is now captured by means of the optical capture device, the ratio of the already covered route to the respective portion can be calculated by means of the electronic computing device and the multidimensional position of the transport means in the space can be ascertained or calculated therefrom as a function of the multidimensional reference position, in particular the respective first reference marking and/or the respective second reference marking.

In a further embodiment, it is provided that a rotational position, which is current in particular, of the transport means, in particular around at least one axis of rotation, in the space is ascertained by means of the electronic computing device as a function of the captured marking. In other words, the variable characterizing the marking is used as an input variable, by means of which the rotational position, which is current in particular, of the transport means in the space is ascertained or calculated. The rotational position of the transport means can be particularly important, for example, during an assembly process. For example, it can thus be ensured that the current rotational position is suitable for the respective assembly process, i.e., it is the correct rotational position. A quality of the produced motor vehicles can thus be increased in particular. This applies in particular for local processes, in which in particular a tool intervention of a tool is carried out using the part arranged at or on the transport device. The tool intervention can be, for example, a screwing action. For example, the assembly process, in particular the screwing action, is carried out, for example, automatically, when a first angle value is ascertained as the rotational position, which is current in particular, of the transport means by means of the electronic computing device, wherein the assembly process, in particular the screwing action, is not carried out if a second angle value, different from the first angle value, is ascertained as the rotational position, which is current in particular, of the transport means in the space by means of the electronic computing device.

For example, an initial rotational position of the transport means can be known. In particular if the portion on which the respective transport means is currently located is designed as a curve, the rotational position of the transport means can be ascertained by means of the electronic computing device as a function of the captured marking, and in particular as a function of geometric parameters of the curve, for example curve radius and/or pivot point or center point. This means that in particular during cornering of the transport means, as a function of a prior rotational position which the transport means has at the previously captured marking, the current rotational position of the transport means in the space can be ascertained as a function of the currently captured marking. Alternatively or additionally, it can be provided that the rotational position of the transport means is changed independently of the travel path, in particular the cornering. In particular if the transport means is designed as a hanger, the transport means can be actively adjusted or pivoted, for example, by means of a suspension device. The rotation or adjustment of the transport means can be captured, for example, by means of a sensor device designed separately from the optical capture device. Alternatively or additionally, further optical markings provided additionally to the optical markings, which can be designed, for example, as further barcodes, can be provided, by means of which the rotation or the adjustment can be captured by means of the optical capture device. This means that the rotational position, which is current in particular, of the transport means in the space can be ascertained or calculated by means of the electronic computing device as a function of at least one captured further marking.

In particular in a conventional method based on radio triangulation, the ascertainment of the rotational position typically may not be possible. An advantage can therefore be achieved in relation to the radio localization by the ascertainment of the rotational position.

The rotational position can be understood in particular as a rotation or an alignment, which is current in particular, of the transport means in the space.

In a further embodiment, it is provided that the at least one variable characterizing the marking, in particular the barcode, is captured by means of the optical capture device, which is transferred, in particular transmitted, from the second electronic computing device, designed separately from the first electronic computing device, by means of OPC unified architecture to the first electronic computing device. In other words, to transfer, in particular transmit, the variable characterizing the at least one marking from the second electronic computing device to the first electronic computing device, the OPC unified architecture is used as an architecture provided for data transmission, in particular a software architecture. The variable characterizing the marking can thus particularly advantageously be transmitted or transferred, in particular with particularly little effort and particularly reliably.

Alternatively or additionally, the transmission or the transfer can be carried out, for example, by means of DB fetching or by means of RFC 1006 telegrams. This means that the electronic computing device can operate, for example, various interfaces, which can be, for example, OPC unified architecture, DB fetching, or RFC 1006 telegrams.

OPC unified architecture (OPC UA) can be understood in particular as a standard for data exchange as a platform-independent, service-oriented architecture (SOA). DB fetching can be understood in particular as direct retrieval from a preprepared data module.

A second aspect of the disclosure relates to a conveyor system for transporting at least one component. In particular a method according to the first aspect of the disclosure can be carried out by means of the conveyor system. Advantages and advantageous embodiments of the first aspect of the disclosure are to be considered advantages and advantageous embodiments of the second aspect of the disclosure and vice versa.

The conveyor system has at least one transport means comprising an optical capture device for conveying the at least one component through the conveyor system. For example, the conveyor system comprises a conveyor device which comprises the transport means. The conveyor system preferably has multiple transport means, in particular a large number of transport means. The conveyor system, in particular the conveyor device, has a travel path along which in particular at least one route section of the conveyor system can be traveled through by the transport means. Furthermore, the conveyor system comprises at least one electronic computing device. The electronic computing device can be spaced apart from the conveyor device. The electronic computing device can be located close to the conveyor device or the electronic computing device can be remote in position, in particular far away, from the conveyor device, due to which the electronic computing device can be designated or designed in particular as an external electronic computing device. The electronic computing device can be connected, for example, via a network connection to the conveyor device, in particular to the respective transport means, in particular in a data-transmitting manner.

To be able to ascertain a position of the transport means with particularly little effort and particularly precisely, it is provided according to the disclosure that at least one, in particular optical, marking is arranged in the area of the travel path, which can be captured by means of the optical capture device of the transport means and a multidimensional, in particular two-dimensional or three-dimensional, position, which is current in particular, of the transport means in the space, in particular in the conveyor system, is ascertainable by means of the electronic computing device as a function of the captured marking.

In a further embodiment it is provided that the transport means is designed as a route-bound or path-bound transport means. For example, the transport means is designed as a rail-bound transport means, in particular as a rail-bound vehicle or as a rail-bound hanger. In other words, the travel path of the conveyor system is designed as a rail on which or along which the route section of the conveyor system can be traveled through by the transport means. This means that the conveyor system, in particular the conveyor device, has at least one rail, in particular multiple rails, on which the conveyor system can be traveled through by the transport means. The respective component can thus be transported particularly advantageously, in particular with particularly little effort and/or particularly safely, to a destination location.

The respective rail preferably extends along the travel path. This can be understood in particular to mean that the travel path is defined or formed by the respective rail.

In a further embodiment, it is provided that the at least one, in particular optical, marking is arranged on a surface of the at least one rail. In other words, the rail comprises the surface on which the at least one marking is located. The respective marking can thus be captured by means of the optical capture device particularly advantageously, in particular with particularly little effort and/or particularly precisely or reliably, as the transport means travels through the conveyor system.

Further features of the disclosure result from the claims, the figures, and the description of the figures. The features and combinations of features mentioned above in the description and the features and combinations of features mentioned hereinafter in the description of the figures and/or solely shown in the figures are usable not only in the respective specified combination, but also in other combinations or alone.

The disclosure will now be explained in more detail on the basis of a preferred exemplary embodiment and with reference to the drawings. In the figures:

### BRIEF DESCRIPTION OF THE DRAWINGS

FIG. 1 shows a schematic and perspective partial view of a conveyor system according to the disclosure, which is operable by means of a method according to the disclosure; and

FIG. 2 shows a schematic top view of a conveyor system according to the disclosure; and

FIG. 3 shows a schematic top view of a travel path of a conveyor system according to the disclosure; and

FIG. 4 shows a schematic top view of a marking of a conveyor system according to the disclosure; and

FIG. 5 shows a schematic and perspective partial view of a conveyor system according to the disclosure; and

FIG. 6 shows a schematic flow chart to illustrate components of a conveyor system according to the disclosure; and

FIG. 7 shows a schematic diagram to illustrate an ascertainment of a multidimensional position of a transport means, located on a portion of a travel path designed as a straight line, of a method according to the disclosure; and

FIG. 8 shows a schematic diagram to illustrate an ascertainment of a multidimensional position of a transport means, located on a portion of a travel path designed as a straight line, of a method according to the disclosure; and

FIG. 9 shows a schematic diagram to illustrate an ascertainment of a multidimensional position of a transport means, located on a portion of a travel path designed as a curve, of a method according to the disclosure; and

FIG. 10 shows a schematic diagram to illustrate an ascertainment of a multidimensional position of a transport means, located on a portion of a travel path designed as a curve, of a method according to the disclosure; and

FIG. 11 shows a schematic top view of a conveyor system according to the disclosure according to a further embodiment; and

FIG. 12 shows a schematic structure of a tag ID; and

FIG. 13 shows a schematic flow chart to illustrate components of a conveyor system according to the disclosure.

### DETAILED DESCRIPTION OF THE DRAWINGS

In the figures, identical or functionally identical elements are provided with identical reference signs.

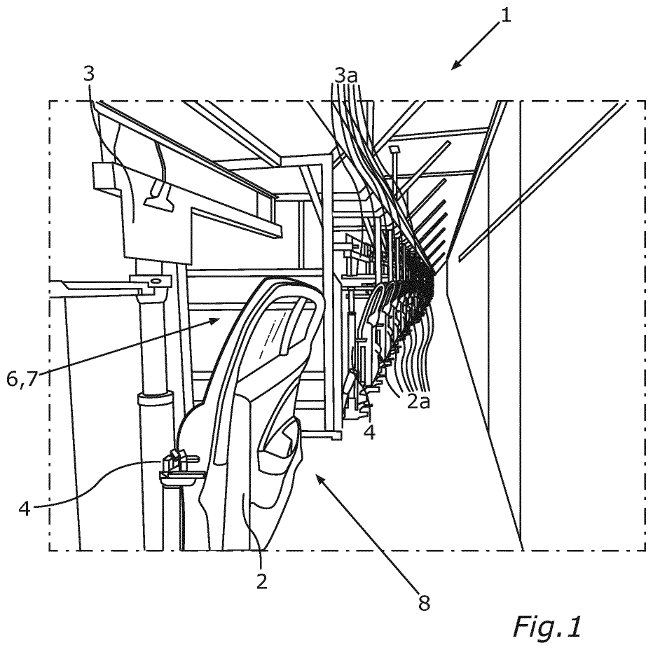

FIG. 1 shows a schematic and perspective partial view of a conveyor system 1 for transporting at least one component 2. The conveyor system 1 has a conveyor device, which comprises at least one transport means 3. The component 2 is arranged on the transport means 3 or held on the transport means 3, due to which the component 2 can be conveyed by means of the transport means 3 through the conveyor system 1. In the exemplary embodiment shown in FIG. 1, the conveyor system 1, in particular the conveyor device, comprises multiple transport means 3, 3a. This means that the conveyor system 1, in particular the conveyor device, comprises the transport means 3, which is in particular designated as the first transport means 3, and further transport means 3a designed separately from the first transport means 3. Multiple components 2, 2a can thus be transported by means of the conveyor system 1. This means that the component 2 designated in particular as the first component 2 is arranged, in particular fastened, on the first transport means 3 and at least one further component 2a is arranged, in particular fastened, on each of the further transport means 3a. For example, the respective transport means 3, 3a has a receptacle device 4 in each case, on which the respective component 2, 2a is fastenable or arrangeable. The respective transport means 3, 3a is designed for conveying the at least one respective component 2, 2a through the conveyor system 1. In the exemplary embodiment shown in FIG. 1, the respective component 2, 2a is designed in each case as a door of a motor vehicle.

The respective transport means 3, 3a is preferably designed as a path-bound or route-bound transport means 3, 3a. The respective transport means 3, 3a is particularly preferably designed as a rail-bound transport means 3, 3a. The conveyor system 1, in particular the conveyor device, therefore has at least one rail 5 on which the respective transport means 3, 3a can travel through the conveyor system 1.

For example, the conveyor system 1 is part of a manufacturing plant which is designed for motor vehicle production. The manufacturing plant is designed, for example, for carrying out at least one assembly process. For example, the respective component 2, 2a, in particular the door, is transported by means of the conveyor system 1 to an assembly location, in particular the manufacturing plant, wherein at least one assembly process is carried out at the assembly location. During the assembly process, the respective component 2, 2a, in particular the respective door, can be fastened or assembled, for example, on a body of the motor vehicle. Alternatively, for example, an element formed separately from the respective component 2, 2a can be fastened or assembled on the respective component 2, 2a, in particular the respective door.

The conveyor system 1 has at least one travel path 6, along which the respective transport means 3, 3a can travel through at least one route section 7 of the conveyor system 1. In the exemplary embodiment shown in FIG. 1, the respective transport means 3, 3a is designed as a respective hanger. This means that the conveyor device can be designed in particular as an electrified monorail system (EMS). The travel path 6, in particular the route section 7, is at least partially, in particular completely, formed or delimited by the rail 5. The travel path 6, in particular the route section 7, can thus be designed in particular as a rail path.

The conveyor system 1 is designed to carry out a method for ascertaining a multidimensional, in particular two-dimensional or three-dimensional, position 8, which is current in particular, of the respective transport means 3, 3a of the conveyor system 1 intended to transport the respective at least one component 2, 2a. During the method, the respective transport means 3, 3a travels through at least the route section 7 along the travel path 6.

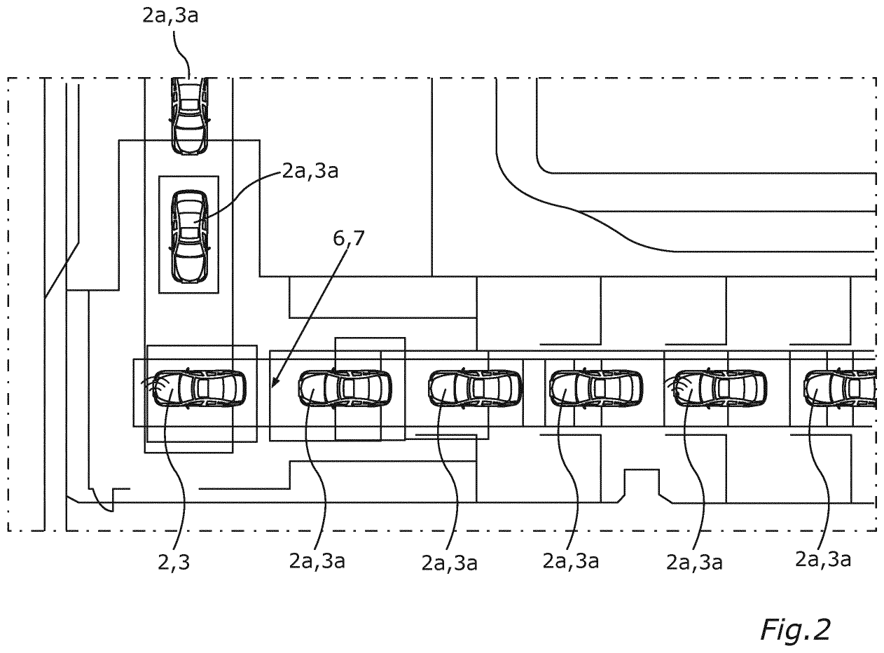

FIG. 2 shows the conveyor system 1 according to a further embodiment in a schematic partial view from above, wherein in the exemplary embodiment shown in FIG. 2, the respective component 2, 2a is designed as a respective motor vehicle. The respective motor vehicle may be in a completely produced state or may be in a not completely produced state.

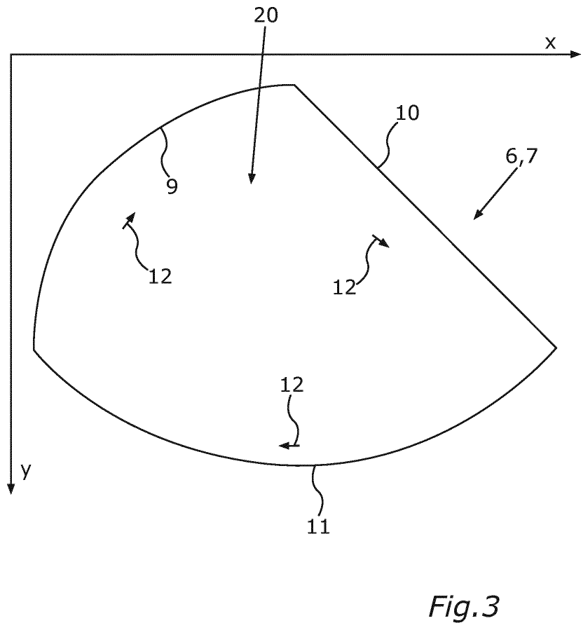

FIG. 3 shows a schematic diagram to illustrate the travel path 6 or the route section 7. A first spatial direction x is plotted on the abscissa. A second spatial direction y, which is different from the first spatial direction x, is plotted on the ordinate. The travel path 6 is very schematically illustrated in FIG. 3. In particular angles at respective corners or curves are shown particularly schematically in FIG. 3 and can actually deviate, of course, from the representation from FIG. 3. For example, the first spatial direction x is a longitudinal extension direction of the conveyor system 1, in particular the manufacturing plant. For example, the second spatial direction y is a transverse extension direction of the conveyor system 1, in particular the manufacturing plant. The diagram shown in FIG. 3 can therefore be understood in particular as a schematic top view of the conveyor system 1, in particular the travel path 6. In the exemplary embodiment shown in FIG. 3, the travel path 6, in particular the route section 7, comprises three portions 9, 10, 11. A travel direction of the respective transport means 3, 3a in or on the respective portions 9 to 11 is illustrated by means of a respective arrow 12.

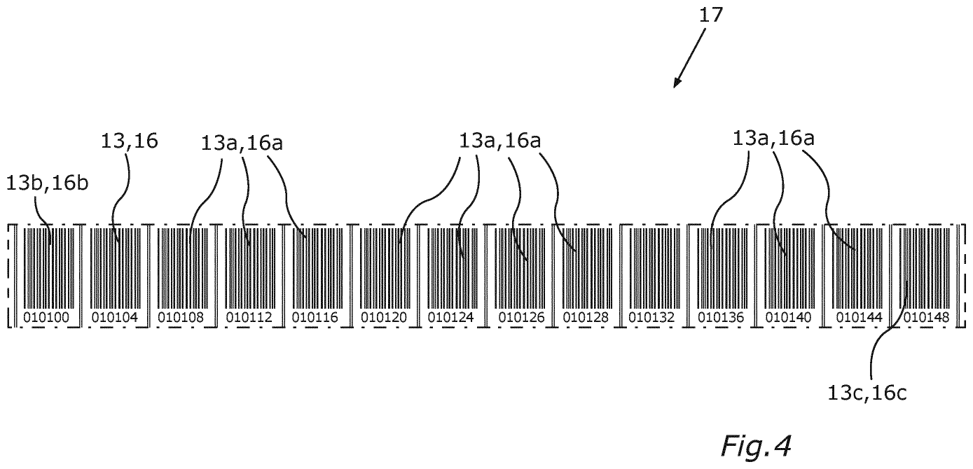

FIG. 4 shows a schematic top view of an, in particular optical, marking 13. The marking 13 is arranged in the area of the travel path 6, in particular the route section 7.

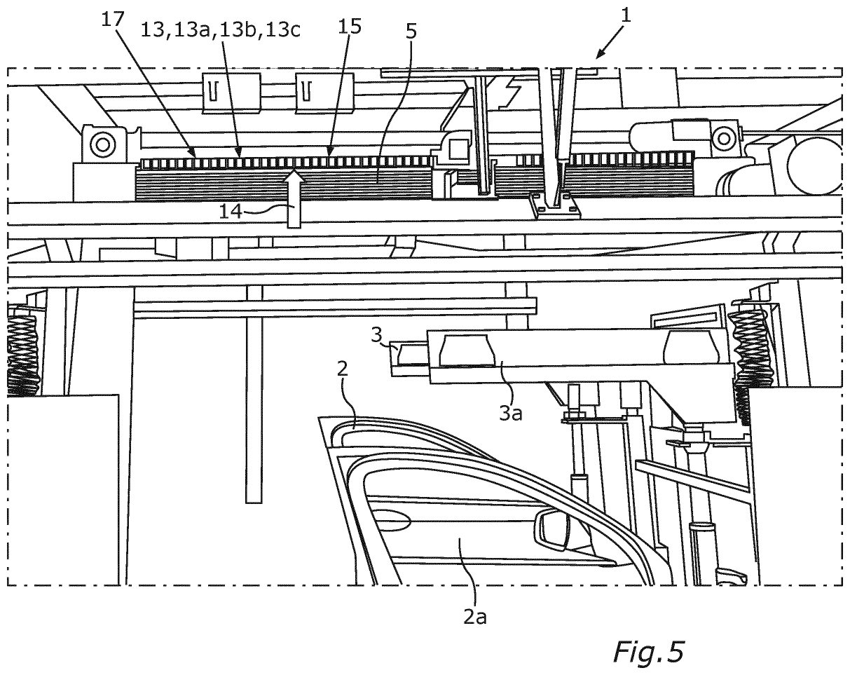

FIG. 5 shows a schematic and perspective partial view of the conveyor system 1, wherein the area in which the marking 13 is arranged is illustrated by means of an arrow 14 in FIG. 5. In the respective embodiment shown in FIG. 4 and FIG. 5, multiple, in particular optical, markings 13, 13a are provided. This means that in the area of the travel path 6, 7, the marking 13 and further markings 13a, which are different from the marking 13, in particular are spaced apart from the marking 13, are arranged. It is preferably provided here that the marking 13 and the further markings 13a are each arranged in the area of the respective portion 9 to 11.

In a further embodiment, it is provided that the respective marking 13, 13a is arranged on a surface 15 of the rail 5. This means that the rail 5 is equipped with the respective marking 13, 13a. For example, after each 4 cm, a new number of a progressive number series is coded on the surface 15. The rail 5, in particular the complete rail path, is preferably continuously provided, in particular laminated, with the respective marking 13, 13a. Alternatively, the surface 15 can be formed separately from the rail 5 and in particular can be spaced apart from the rail 5, wherein the surface 15 is preferably arranged close to the rail 5. With respect to the installed position of the surface 15 in the conveyor system 1 shown in FIG. 5, the view of the respective marking 13, 13a shown in FIG. 4 can be understood in particular as a schematic front view.

In the embodiment shown in FIG. 4, it is provided that the respective marking 13, 13a is designed in each case as a barcode 16, 16a. The markings 13, 13a form a code band 17 designed in particular as an endless barcode. The code band 17 thus comprises the markings 13, 13a, in particular the barcodes 16, 16a, wherein the respective markings 13, 13a, in particular the respective barcodes 16, 16a, are spaced apart from one another. A respective distance between each two adjacent markings 13, 13a is preferably constant.

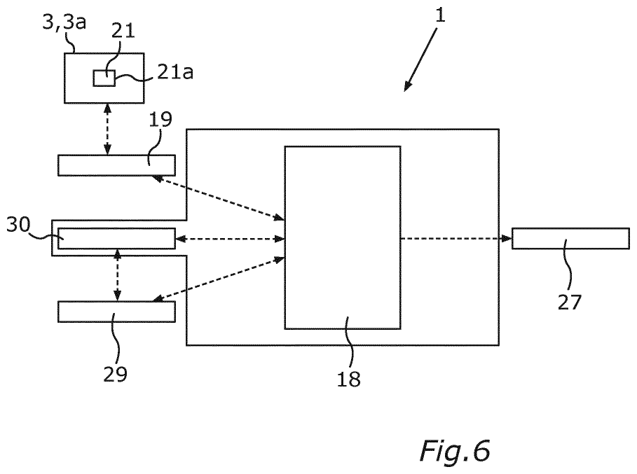

FIG. 6 shows a schematic flow chart of components of the conveyor system 1. The conveyor system 1 has an electronic computing device, designated in particular as the first electronic computing device 18. For example, the first electronic computing device 18 is spaced apart from the conveyor device. The first electronic computing device 18 can in particular be at a remote location from the conveyor device and can be connected or coupled to the respective transport means 3, 3a to transmit data, for example, by means of a network connection. The electronic computing device 18 can therefore be designated in particular as an external electronic computing device. Alternatively, the first electronic computing device 18 may not be part of the conveyor system 1.

The conveyor system 1 comprises a second electronic computing device 19 designed separately from the first electronic computing device 18. The second electronic computing device 18 is preferably designed as a programmable logic controller (PLC). For example, the second electronic computing device 19 is provided for controlling the conveyor system 1. Alternatively, the second electronic computing device 19 can be designed, for example, as an RFID reader. In the exemplary embodiment shown in FIG. 6, the second electronic computing device 19 is connected or connectable in a data-transmitting manner to the respective transport means 3, 3a. The first electronic computing device 18 is connected or connectable in a data-transmitting manner to the second electronic computing device 19. This means that the first electronic computing device 18 can be coupled or is coupled in a data-transmitting manner via the second electronic computing device 19 with the respective transport means 3, 3a.

To be able to ascertain the multidimensional position 8 of the respective transport means 3, 3a in the space 20 with particularly little effort and particularly precisely, it is provided that the respective transport means 3, 3a has an optical capture device 21 in each case, by means of which the respective marking 13, 13a arranged in the area of the travel path 6 can be captured, wherein the multidimensional position 8, which is current in particular, of the respective transport means 3, 3a in the space 20 is ascertainable by means of the first electronic computing device 18 as a function of the captured respective marking 13, 13a. This means that in the method the respective marking 13, 13a is captured by means of the optical capture device 21 of the respective transport means 3, 3a and the multidimensional, in particular two-dimensional or three-dimensional position 8, which is current in particular, of the respective transport means 3, 3a in the space 20 is ascertained by means of the first electronic computing device 18 as a function of the respective captured marking 13, 13a. The space 20 can be understood in particular as a space of the conveyor system 1, in particular the manufacturing plant, wherein the travel path 6 can be arranged in the space 20. In particular, the space 20 can be understood as a multidimensional environment of the travel path 6. This means that the multidimensional position 8 does not relate to a travel route of the travel path 6, but rather to the environment of the travel path 6. In the exemplary embodiment shown in FIG. 3, the multidimensional position 8 is a two-dimensional position 8 with respect to the two spatial directions x, y. Alternatively, the multidimensional position 8 can be a three-dimensional position, which relates to three spatial directions. The multidimensional position 8 can be designated in particular as a multidimensional spatial position. For example, at least one variable 21a characterizing the respective marking 13, 13a is captured by means of the optical capture device 21.

By means of the method, the respective multidimensional position 8 of the respective transport means 3, 3a in the space 20 can be produced with particularly little effort and in particular particularly cost-effectively, in particular in relation to a conventional method based on radio triangulation. Furthermore, the respective multidimensional position 8 can be ascertained particularly precisely and particularly reliably or with particularly little susceptibility to interference, in particular in relation to radio triangulation.

For example, a respective barcode value is captured using the optical capture device 21 upon the capture of the respective barcode 16, 16a, wherein the barcode values are different from one another.

It is preferably provided that the respective marking 13, 13a is captured by means of the optical capture device 21, while the respective transport means 3, 3a travels through the conveyor system 1, in particular the travel path 6 or the route section 7 or the space 20. This means that the respective transport means 3, 3a moves relative to the rail 5 upon the capture of the respective marking 13, 13a.

It is provided in the exemplary embodiment that geometric properties of the travel path 6, in particular the rail path, to ascertain the current multidimensional position 8 of the respective transport means 3, 3a on the basis of the captured respective marking 13, 13a, which is current in particular, in particular on the basis of a current barcode value. The rail path can be broken down into geometric basic components in the form of straight lines and curves. This is illustrated in FIG. 3 in the form of the portions 9 to 11. A first of the portions 9 is designed as a curve. A second of the portions 10 is designed as a straight line. The third of the portions 11 is designed as a curve. Curves are implemented in the exemplary embodiment as circular arcs. Alternatively, an elliptical arc can be provided instead of each of the curves. A function is now sought which assigns each of the markings 13a, 13, in particular each barcode 16, 16a or the respective barcode value, a respective location vector \vec{v} of a corresponding respective point on the corresponding geometric basic component. The respective basic component can be understood in particular as a respective geometry component. The respective multidimensional position 8 of the respective transport means 3, 3a in the space 20 can be described by the respective location vector \vec{v}. This is initially explained by way of example on the basis of a straight line hereinafter.

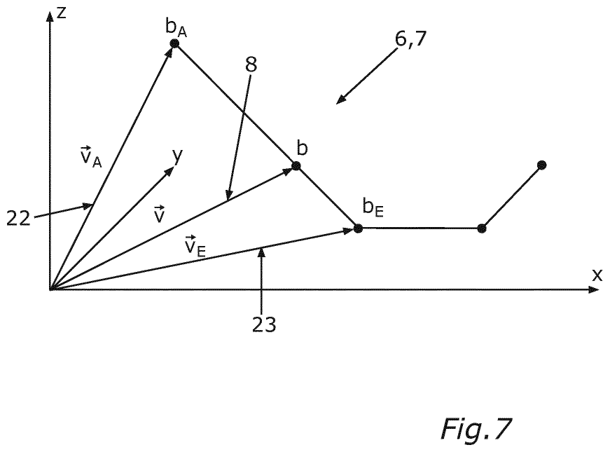

FIG. 7 shows a schematic diagram to illustrate the travel path 6, in particular the route section 7. The first spatial direction x is plotted on the abscissa. A third spatial direction z is plotted on the ordinate. The second spatial direction y is plotted on the applicate.

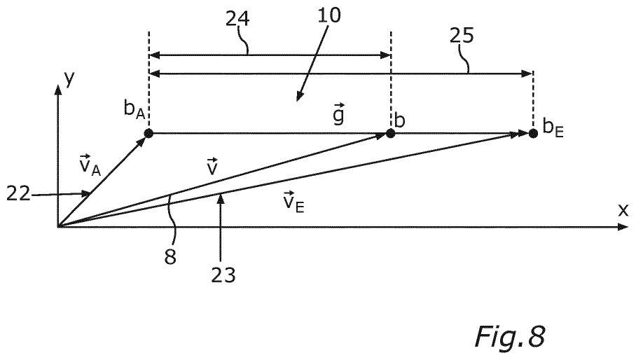

FIG. 8 shows a schematic diagram to illustrate a portion 10 of the travel path 6 designed as a straight line. The first spatial direction x is plotted on the abscissa. The second spatial direction y is plotted on the ordinate. The respective portion 9 to 11 has in each case two reference points b_{A}, b_{E}, wherein in the exemplary embodiment a first of the reference points b_{A} is a start or a starting point of the respective portion 9 to 11 and the second reference point b_{E} is an end or an end point of the respective portion 9 to 11. A first, in particular optical, reference marking 13b is arranged in the area of the first reference point b_{A}, in particular at the first reference point b_{A}. A second reference marking 13c, which is different from the first reference marking 13b, is arranged in the area of the second reference point b_{E}, in particular at the second reference point b_{E}. The respective reference marking 13b, 13c is preferably designed as a barcode or as a reference barcode 16b, 16c in each case. The respective reference marking 13b, 13c is preferably arranged on the surface 15.

A respective multidimensional, in particular two-dimensional or three-dimensional, reference position 22, 23 in the space 20 is assigned in each case to the respective reference point b_{A}, b_{E}. This means that a first multidimensional reference position 22, which can be described by a location vector \vec{v}_{A}, is assigned to the respective first reference point b_{A}. A second multidimensional reference position 23, which can be described by a location vector \vec{v}_{E}, is assigned to the second reference point b_{E}. In the respective diagram shown in FIG. 7 and FIG. 8, the respective transport means 3, 3a is located in the portion 10, in particular with respect to the travel path 6, at a position b. The position b is assigned the location vector \vec{v}, by means of which the multidimensional position 8 of the respective transport means 3, 3a in the space 20 can be described. The marking 13, in particular the barcode 16, is arranged in the area of the position b. This means that the marking 13, in particular the barcode 16, is captured by the respective transport means 3, 3a when the respective transport means 3, 3a is currently located at the position b on the respective portion 9 to 11. Therefore, a function is initially sought which supplies the location vector \vec{v} for the current multidimensional position 8 of the respective transport means 3, 3a as a function of the marking 13 captured by means of the optical capture device 21 of the respective transport means 3, 3a located at the position b, and in particular as a function of a respective type of the geometry component.

For a ratio τ between a distance 24 of a route section of the respective portion 9 to 11, covered by the respective transport means 3, 3a upon the capture of the respective marking 13, and a total length 25 of the respective portion 9 to 11, in particular if the respective markings 13, 13a are arranged linearly on the portion 10 designed as a straight line, the following relationship applies:

$$\frac{\vert \vec{v} - {\vec{v}}_{A} \vert}{\vert {\vec{v}}_{E} - {\vec{v}}_{A} \vert} = \frac{b - {b}_{A}}{{b}_{E} - {b}_{A}} = τ$$

Therefore, the ratio τ, which is designated in particular as a factor, describes a fraction of the total length 25 of the respective portion 10 already covered by the respective transport means 3, 3a. The distance 24 can be understood in particular as a distance 24 to be covered or already covered by the respective transport means 3, 3a on the travel path 6, in particular on the portion 10, between the captured marking 13 and the first reference point b_{A}.

The location vector \vec{v} can be described by a compression of a vector \vec{g} by the factor τ:

$$\vec{g} = {\vec{v}}_{E} - {\vec{v}}_{A}$$

$$\vec{v} = {\vec{v}}_{A} + τ \vec{g} = {\vec{v}}_{A} + τ ( {\vec{v}}_{E} - {\vec{v}}_{A} ) .$$

The following relationship follows therefrom for the location vector 1 by insertion and rearrangement:

$$\vec{v} = {\vec{v}}_{A} + ( \frac{b - {b}_{A}}{{b}_{E} - {b}_{A}} ) ( {\vec{v}}_{E} - {\vec{v}}_{A} ) = {\vec{v}}_{A} + \vec{g} ( \frac{1}{{b}_{E} - {b}_{A}} ) ( b - {b}_{A} )$$

The multidimensional position 8 of the respective transport means 3, 3a in the space 20 can therefore be ascertained or calculated by means of the electronic computing device 18 as a function of the multidimensional first reference position 22, assigned to the first reference point b_{A}, of the first reference point b_{A} in the space 20, and in particular as a function of the multidimensional second reference position 23, assigned to the second reference point b_{E}, of the second reference point b_{E} in the space 20. Furthermore, the distance 24 to be covered or already covered by the respective transport means 3, 3a on the travel path 6, in particular on the portion 10, between the captured marking 13 and the first reference point b_{A} can be ascertained or calculated by means of the electronic computing device 18 as a function of the captured marking 13, as a function of which distance the multidimensional position 8 of the respective transport means 3, 3a in the space 20 can be ascertained or calculated by means of the electronic computing device 18.

In particular the term

$$\vec{g} ( \frac{1}{{b}_{E} - {b}_{A}} )$$

is known in the portion 10 or in the travel path 6, due to which a pre-calculation is possible. Thus, for example, a computing time for ascertaining the multidimensional position 8 by means of the electronic computing device 18 can be kept particularly short. Therefore, for example, to ascertain the location vector \vec{v} and thus the multidimensional position 8, only a multiplication of this term with a difference of b and b_{A} and a subsequent vector addition with the location vector \vec{v} can be necessary.

For a complete orientation of an object which moves on a straight line, an intrinsic coordinate system of the object can be necessary. This can be generated as follows, for example: The location vector \vec{v} in the form of a tangential vector can be used as the new x axis. A plane is now observed which is spanned by \vec{v} and a projection of \vec{v} on a x-y plane. A new z axis is in this plane and arises by rotation of \vec{v} by 90°. The new z axis can be described by a normal vector of this plane. If \vec{v} extends parallel to the x axis, a projection of \vec{v} on the x-y plane can disappear. For this case, a further geometry element provided in addition to the respective straight line and the respective curve can be created, which can be designated in particular as an elevator. A calculation of the respective location vector \vec{v} can be carried out in the elevator analogously to the straight line. The elevator can therefore be understood in particular as a further straight line which extends diagonally or perpendicularly to the straight line, wherein the further straight line comprises a vertical component. The elevator can therefore be understood in particular as a special case of the straight line, which extends vertically upward, for example.

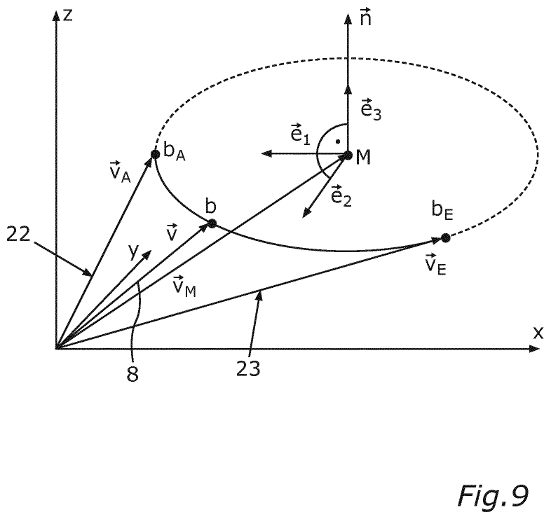

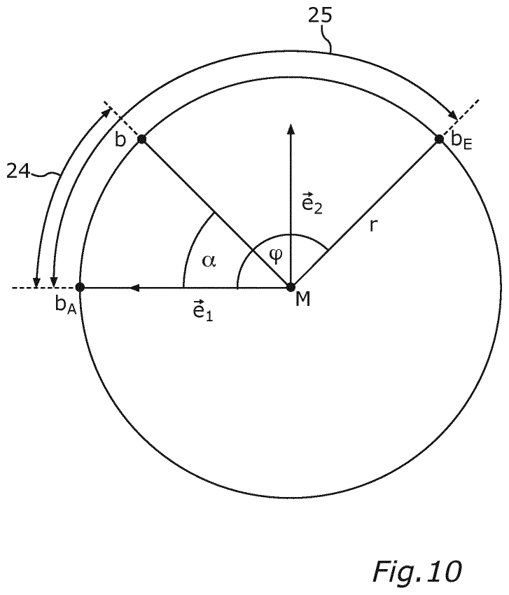

FIG. 9 shows a schematic diagram of an illustration of the respective portion 9, 11 of the travel path 6 designed as a curve. The first reference point b_{A} thus corresponds to a starting point of the curve in FIG. 9 and the second reference point b_{E} corresponds to an end point of the curve. M is a center point of the curve. \vec{v}_{M} is a location vector of the center point M. FIG. 10 shows a schematic top view of the respective portion 9, 11 designed as a curve in a plane designated in particular as a curve plane.

Analogously to the example already explained on the basis of the straight line, a function is sought which supplies the location vector \vec{v} and thus the multidimensional position 8 of the respective transport means 3, 3a for the respective barcode value captured at the position b or for the captured marking 13. The ratio τ can be ascertained as follows for the curve analogously to the exemplary embodiment explained on the basis of the straight line:

$$τ = \frac{α}{φ} = \frac{b - {b}_{A}}{{b}_{E} - {b}_{A}}$$

$$τ = arc cos = \frac{\vec{{Mb}_{E}} \cdot \vec{{Mb}_{A}}}{\vert \vec{{Mb}_{E}} \vert \vert \vec{{Mb}_{A}} \vert}$$

A fraction of the already covered total length 25 for the respective transport means 3, 3a located at b can thus be described by φ. Therefore, α corresponds to an already covered angle and φ corresponds to a total angle of the curve.

A base {\vec{e}₁, \vec{e}₂, \vec{e}₃} can be constructed, with the aid of which a plane can be described, within which the curve is located. The unity vector \vec{e}₁ can be described as follows by scaling:

$${\vec{e}}_{1} = \frac{\vec{{Mb}_{A}}}{\vert \vec{{Mb}_{A}} \vert} = \frac{\vec{{Mb}_{A}}}{r}$$

The following results therefrom for M̅b̅:

$$\vec{Mb} = r ( {\vec{e}}_{1} cos α + {\vec{e}}_{2} sin α )$$

$$α = \frac{φ ( b - {b}_{A} )}{{b}_{E} - {b}_{A}}$$

The following applies for the unity vectors \vec{e}₂, \vec{e}₃:

$${\vec{e}}_{3} = \frac{\vec{n}}{\vert \vec{n} \vert} = \frac{{\vec{e}}_{1} \times \vec{{Mb}_{E}}}{\vert {\vec{e}}_{1} \times \vec{{Mb}_{E}} \vert}$$

$${\vec{e}}_{2} = {\vec{e}}_{3} \times {\vec{e}}_{1}$$

The following follows therefrom for the location vector \vec{v} by insertion and rearrangement:

$$\vec{v} = {\vec{v}}_{M} + r ( {\vec{e}}_{1} cos α + {\vec{e}}_{2} sin α )$$

$$α = \frac{φ ( b - {b}_{A} )}{{b}_{E} - {b}_{A}} .$$

Alternatively, for example, it is possible to approximate the respective curve by way of multiple straight lines, in particular a large number of straight lines. A respective computing time can thus be kept particularly short, for example. However, this can have a disadvantageous effect on the accuracy. In contrast, in the exemplary embodiment described on the basis of FIG. 9 and FIG. 10, the multidimensional position 8 of the respective transport means 3, 3a can be ascertained particularly precisely.

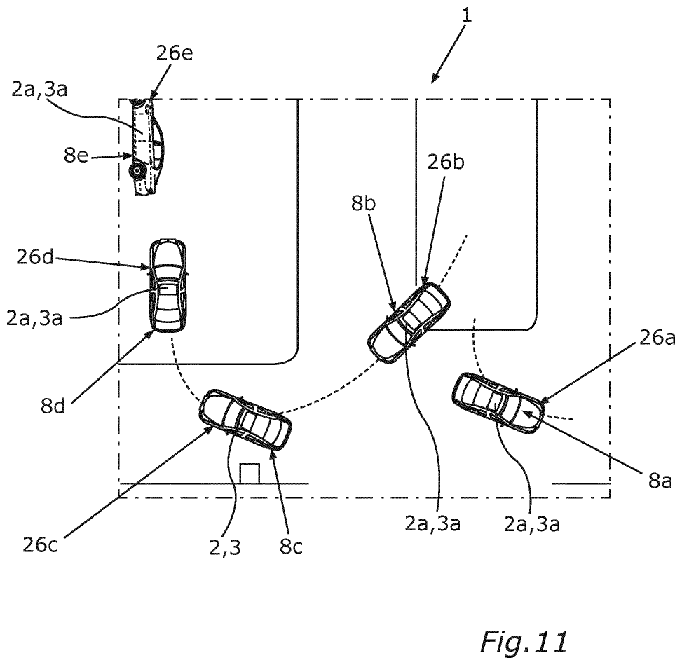

FIG. 11 shows the conveyor system 1 according to a further embodiment in a schematic partial view from above. In the embodiment shown in FIG. 11, it is provided that a respective rotational position 26a to e of the respective transport means 3, 3a is changed while the respective transport means is located on the route section 7 of the travel path 6, in particular while the respective transport means 3, 3a travels through the conveyor system 1.

FIG. 11 shows the respective transport means 3, 3a at five positions 8a to e different from one another in the space 20. At a first of the positions 8a, the respective transport means 3, 3a is in a first of the rotational positions 26a. At a second of the positions 8b, the respective transport means 3, 3a is in a second of the rotational positions 26b. At a third of the positions 8c, the respective transport means 3, 3a is in a third of the rotational positions 26c. In a fourth of the positions 8d, the respective transport means 3, 3a is in a fourth of the rotational positions 26d. In the fifth of the positions 8e, the respective transport means 3, 3a is in the sixth of the rotational positions 26e. In the exemplary embodiment shown in FIG. 11, the rotational positions 26a to e are different from one another.

In a further embodiment, it is provided that the respective rotational position 26a to e, which is current in particular, of the respective transport means 3, 3a in the space 20 is ascertained, in particular by means of the first electronic computing device 18. It is provided here, for example, that the respective rotational position 26a to e, which is current in particular, of the respective transport means 3, 3a in the space 20 is ascertained by means of the electronic computing device 18 as a function of the captured respective marking 13, 13a.

It is preferably provided that the variable 21a characterizing the respective marking 13, 13a is transferred from the second electronic computing device 19 by means of OPC unified architecture (OPC-UA) to the first electronic computing device 18. This means that the variable 21a and thus a position, designated in particular as a 1D position, of the respective transport means 3, 3a on the route section 7 is provided via OPC-UA by the second electronic computing device 19 to the first electronic computing device 18, in particular for position processing. Alternatively or additionally, the variable 21a can be transferred or transmitted by means of DB fetching and/or by means of an RFC 1006 telegram from the second electronic computing device 19 to the first electronic computing device 18. The transfer from the second electronic computing device 19 to the first electronic computing device 18 can thus be possible via various protocols. DB fetching can be understood in particular as a retrieval, designated as fetching, from a data module, in particular an S7 data module. Alternatively, the transfer can be carried out by means of further protocols, such as Kafka or MQTT.

This can be understood in particular as follows: The conveyor system 1, in particular the respective transport means 3, 3a, can be controlled via the second electronic computing device 19, wherein this can provide different connection options, for example. It can therefore be advantageous, independently of a design or a version of the second electronic computing device 19, to forward the barcode data. It is therefore advantageous to provide a system which can provide different protocols for application. Ideally, the second electronic computing device 19 can be a respective electronic computing device which can provide an OPC-UA server, can send RFC 1006 telegrams, and/or can provide a content of a data module via the Siemens S7 protocol. For example, it can be possible to be able to connect further protocols. It can be presumed that in particular a communication of the PLC or of PLCs can be subject to continuous development. A connection of further protocols can therefore be possible, such as MQTT or Kafka, in particular by cloud connections.

In the exemplary embodiment shown in FIG. 6, the manufacturing plant comprises a third electronic computing device 27 designed separately from the electronic computing devices 18, 19. The third electronic computing device 27 can be part of the conveyor system 1 or can be designed separately from the conveyor system 1. The third electronic computing device 27 can be designated in particular as a PS-i. The third electronic computing device 27 is connected or connectable in a data-transmitting manner to the first electronic computing device 18, in particular directly. For example, it is provided that the respective multidimensional position 8 of the respective transport means 3, 3a ascertained by means of the first electronic computing device 18 is transferred, in particular as a respective SLMF message, for example as a standardized SLMF message, from the first electronic computing device 18 to the third electronic computing device 27, in particular for further processing. The SLMF message can be understood in particular as an SLMF message according to ISO/IEC 24730-1:2014.

The respective multidimensional position 8 of the respective transport means 3, 3a in the space 20 is transmitted from the first electronic computing device 18 to the third electronic computing device 27. This means that occurring items of location information are fed into the IPS-i. The items of location information or the respective multidimensional position 8 can be processed by means of the third electronic computing device 27. The respective multidimensional position 8 of the respective transport means 3, 3a can be linked, for example, to at least one further item of information in each case. The respective further information can be, for example, an identification number of the respective transport means 3, 3a and/or the respective component 2, 2a or the respective motor vehicle. The identification number can therefore be, for example, a vehicle identification number (VIN). It can thus be known, in particular in real time, where the respective transport means 3, 3a, in particular the respective component 2, 2a or the respective motor vehicle, is located. Different applications, designated in particular as use cases, can thus be carried out in particular by means of the third electronic computing device 27. In particular during the assembly process, for example, employees can thus be informed or warned when rarely built models are approaching. Errors during the assembly can thus be avoided, due to which in particular the quality of the produced motor vehicles can be increased in particular. This can be designated in particular as an exotic alarm. Alternatively or additionally, at least one important item of information for carrying out the assembly process can be displayed to the employees, for example, in particular per cycle. The important information can relate, for example, to whether the respective motor vehicle is designed as a right-hand drive or as a left-hand drive. An overview of the respective employee of the assembly process can thus especially be increased in particular. Errors can thus be avoided in particular, for example, and the quality of the produced motor vehicles can be increased in particular. Alternatively or additionally, it can be possible to only operate at least one device of the manufacturing plant when this is required for the respective assembly process. The device can thus be protected, for example, when it is not actually required. A power consumption can thus be kept particularly low, for example. The respective device can be, for example, a camera or a scanner. Alternatively or additionally, in the respective assembly process, for example, a tool can be set or adapted, in particular automatically, for the respective assembly process. For example, a screwing device can automatically select a correct torque when a specific motor vehicle approaches for the assembly process. The quality of the produced motor vehicles can thus be increased in particular, for example.

For example, if a motor vehicle enters an assembly hall fully painted, at least one item of information about the motor vehicle can be linked in an automated manner with its position in the space 20 by means of the third electronic computing device 27. This information can be, for example, the identification number, a destination country, and/or a vehicle type of the motor vehicle. A specific process can thus be carried out deliberately, for example, in particular in an automated manner, when a motor vehicle of a defined vehicle type having a defined destination country is located at the corresponding position. The process can be, for example, an assembly process and/or switching on the device, which can be designed in particular as a scanner.

For example, it can be recognized, in particular automatically, whether the assembly process which is to be carried out or has been carried out involves the respective correct component 2, 2a. For example, an automatic acknowledgment, in particular an automatic scanning, of a successfully carried out assembly process can be carried out as a function of the respective position 8. A quality of the produced motor vehicles can thus be increased in particular, for example. In particular, errors can be avoided. Furthermore, an expenditure of the motor vehicle production can be kept particularly low.

The first electronic computing device 18 is capable of obtaining knowledge about the location of the respective transport means 3, 3a in the space 20 from the currently captured barcode value for the respective transport means 3, 3a. This can take place with higher precision than is possible using a conventional system based on radio triangulation. An inaccuracy of the respective ascertained multidimensional position 8 is, for example, less than ±30 cm.

The respective transport means 3, 3a is in particular a moving object. This can move along, for example, with a main belt or another belt of the conveyor system 1 and/or the manufacturing plant. In particular in the area of the main belt, the respective transport means 3, 3a can have a velocity of one cycle per 57 seconds. The cycle can have a length of 6 m, for example. In particular a velocity of, for example, 10 cm/s can follow therefrom for the respective transport means 3, 3a. If one were to locate an object having this velocity once in three seconds, for example, an inaccuracy of ±30 cm would result therefrom, which can correspond, for example, to the inaccuracy of the conventional system based on radio triangulation. To be even more accurate, a localization per object thus has to be carried out more often than every three seconds. A frequency of 1 Hz or more is ideal, for example. An inaccuracy in the range of ±10 cm or less would follow therefrom, for example.

For example, the first electronic computing device 18 is capable of subscribing to value changes on nodes of the OPC-UA server. This is provided for those nodes, for example, in which current barcode values of the respective motor vehicle are stored. Furthermore, for example, processing of lifting height and current orientation is possible. In particular when new barcode values are transferred from the OPC-UA server, the first electronic computing device 18 can calculate the corresponding spatial coordinates as a function of the transferred barcode values and transfer them in particular to the third electronic computing device 27. For example, the first electronic computing device 18 is capable of establishing a TCP connection to the second electronic computing device 19 and receiving RFC 1006 telegrams. In particular if the electronic computing device 18 receives an RFC 1006 telegram having new barcode values, the electronic computing device 18 can calculate the corresponding spatial coordinates and transfer them to the third electronic computing device 27. For example, the first electronic computing device 18 is capable of reading a data module of the second electronic computing device 19 via the Siemens S7 protocol. The barcode values can be read cyclically from the data module, converted by means of the first electronic computing device 18 into spatial coordinates, and then transferred to the third electronic computing device 27.

For example, the input device 29 is provided, which can be designated in particular as an input system. The input device 29 can be understood in particular as an interface, for example a user interface. By means of the input device 29, for example, a connection of the second electronic computing device 19 to the third electronic computing device 27 can be configured and/or monitored, in particular manually. Alternatively or additionally, for example, the travel path 6, in particular the rail path, can be specified or adapted by means of the input device 29. Alternatively or additionally, master data in the system can be manually changed, in particular during running operation, by means of the input device 29. For example, an error robustness of the system can be increased in particular or the system can be autonomously operated by the monitoring.

For example, a database 30 is provided. For example, access data to the second electronic computing device 19 and/or data characterizing the travel path 6, in particular geometry data of the rail path, can be stored in the database 30. The database 30 is connected or connectable in a data-transmitting manner to the electronic computing device 18, due to which, for example, the data stored in the database 30 can be retrieved by the electronic computing device 18. Furthermore, it can be provided that the data stored in the database 30 can be parameterized or adapted, in particular manually, by means of the input device 29.

It is preferably provided that the ascertainment of the multidimensional position 8 of the respective transport means 3, 3a is configurable, in particular dynamically. This means that, for example, changes or adaptations of the travel path 6, in particular the rail path, can be carried out, for example by means of the input device 29, in particular manually. Furthermore, for example, input data, in particular of the first electronic computing device 18, are flexibly designed, which means, for example, that modules for further protocols can be added particularly easily. This means that the method can be carried out using a modular, expandable geometry driver.

In order that the third electronic computing device 27 can identify the respective transport means 3, 3a or the respective component 2, 2a, it can be provided that a unique identification is assigned to the respective transport means 3, 3a or the respective component 2, 2a, which can be designated in particular as a tag ID 31. The tag ID 31 can be understood in particular as a fixed identification number which can be transferred to the third electronic computing device 27.

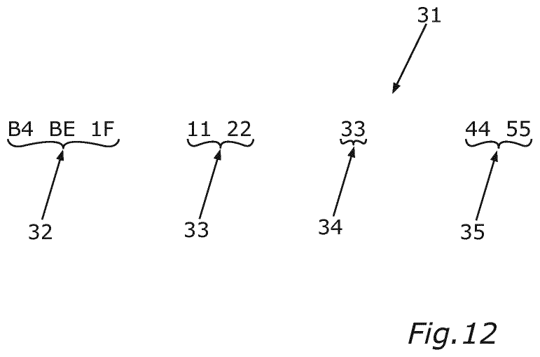

FIG. 12 shows an example of such a tag ID 31 in a schematic representation. To be able to ensure that no tag ID 31 is assigned twice, i.e. that all tag IDs 31 are different from one another, the respective tag ID can be structured as follows, for example, in particular hierarchically: The first 24 bits (positions 63 to 40) are fixed and can therefore be designated in particular as a fixed value 32. Therefore, 40 bits can be made available for all objects to be located, due to which, for example, approximately 1.1 billion objects can be distinguished from one another. Each instance 33 receives, for example, a 16-bit prefix (positions 39 to 24). 2¹⁶ (65 536) different instances 33 are thus possible. In particular if multiple second electronic computing devices 19, in particular multiple PLCs or multiple RFID readers, are provided, each of the second electronic computing devices 19, in particular each PLC or each RFID reader which is assigned to the respective instance 33 can have an 8-bit prefix (positions 23 to 16) assigned, which can be designated in particular as the computing device value 34. In this way, 256 of the second electronic computing devices 19 are possible per instance 33. The remaining 16 bits are provided, for example, for object consecutive numbering and can therefore be designated in particular as the consecutive numbering 35. In this way, for example, 65 536 objects can be located per second electronic computing device 19.

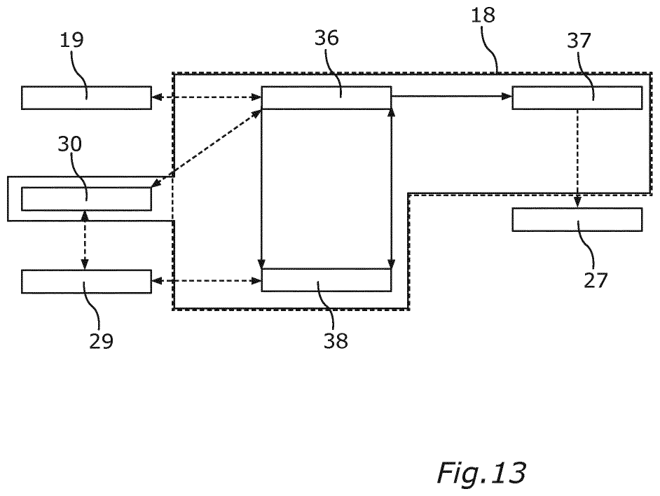

Software for operating the first electronic computing device 19 is preferably modularly designed. This is schematically outlined in FIG. 13. A first connector 36, designated in particular as a PLC connector or as an RFID reader connector, is provided, for example, for communicating with the second electronic computing device 19. The respective barcode values can thus be read from the second electronic computing device 19, for example, via the various protocols. A second connector 37, designated in particular as an IPSI connector, is provided for communicating with the third electronic computing device 27. The respective ascertained multidimensional position 8 is transferred, for example, from the first connector 36 to the second connector 37 and is transferred by means of the second connector 37, for example, in particular via SLMF message, to the third electronic computing device 27. A tracing module 38 is provided in the exemplary embodiment shown in FIG. 13. By means of the tracing module 38, for example, a data connection can be provided between the first electronic computing device 18 and the input device 29. Data or information can be transferred, for example, between the tracing module 38 and the first connector 36, which can be, for example, tracing information and/or tracing commands.

In summary, spatial positions can be calculated by means of the method from endless barcode values by means of the first electronic computing device 18 and these can be transmitted, for example, to the third electronic computing device 27 for further processing. The barcode values can be read from the second electronic computing device 19, which can control the respective transport means 3, 3a. The respective transport means 3, 3a travel via rails, on which the respective barcode 16, 16a can be arranged. Therefore, a functioning position data source for the third electronic computing device 27 can be provided by means of the method. This means that position data for rail-bound objects can be provided, in particular independently of the presence of an RTLS radio coverage. Correct data are delivered to the third electronic computing device 27, i.e. a conversion of barcode values into spatial points is functional. In particular, three types of connection per OPC-UA server, fetching of the data from a data module of the second electronic computing device 19, and receiving the data in RFC 1006 telegrams are furthermore functional in particular. In particular a connection of older programmable logic controllers can thus be made possible, which can, for example, still not be OPC-UA capable. In particular a localization in the space 20, where no RTLS radio evaluation system is available, can therefore be enabled by means of the method. In particular the accuracy of the ascertained multidimensional position 8 is higher than in the case of the radio coverage. In addition, in particular data can be ascertained which a conventional RTLS system cannot provide, for example lifting height and/or pivot angle.

In other words, markings 13, 13a, in particular endless barcode values, can be read by means of the method, wherein spatial positions of the respective transport means 3, 3a can be calculated therefrom with knowledge of the travel path 6, in particular a rail system, and these positions can be fed for further processing into a position data processing system, in particular into the third electronic computing device 27. In particular, RTLS radio coverage is not required. Data characterizing the respective markings 13, 13a can be input, for example, via OPC-UA by means of the first electronic computing device 18 from the second electronic computing device 19. In particular in the presence of an older programmable logic controller without OPC-UA support, alternatively a data module can be read or RFC 1006 telegrams can be received. Software for operating the electronic computing device 18 and thus for carrying out the method is preferably modularly constructed and in particular is expandable. This means that a communication via new protocols can be retrofitted particularly easily. The accuracy of the ascertained multidimensional positions 8 is in particular higher than in the case of RTLS systems. In particular, in the method the lifting height and/or orientation of the respective transport means 3, 3a or the respective component 2, 2a can be ascertained and transferred, for example, to the third electronic computing device 27.

### LIST OF REFERENCE SIGNS

1 conveyor system
2 component
2a further component
3 transport means
3a further transport means
4 receptacle device
5 rail
6 travel path
7 route section
8 multidimensional position
8a first position
8b second position
8c third position
8d fourth position
8e fifth position
9 first portion
10 second portion
11 third portion
12 arrow
13 marking
13a further marking
13b first reference marking
13c second reference marking
14 arrow
15 surface
16 barcode
16a further barcode
16b first reference barcode
16c second reference barcode
17 code band
18 first electronic computing device
19 second electronic computing device
20 space
21 optical capture device
21a variable
22 first reference position
23 second reference position
24 distance
25 total length
26a first rotational position
26b second rotational position
26c third rotational position
26d fourth rotational position
26e fifth rotational position
27 third electronic computing device
29 input device
30 database
31 tag ID
32 fixed value
33 instance
34 computing device value value
35 consecutive numbering
36 first connector
37 second connector
38 tracing module
b_{A} first reference point
b_{E} second reference point
\vec{v} location vector
\vec{v}_{A} location vector
\vec{v}_{E} location vector
x first spatial direction
y second spatial direction
z third spatial direction

1.-10. (canceled)

11. A method for ascertaining a position of at least one transport apparatus configured to transport at least one component of a conveyor system, the method comprising:
capturing at least one marking arranged in an area of a travel path, along which the transport apparatus travels through at least one route section, with an optical capture device of the transport apparatus; and
ascertaining a multidimensional position of the transport apparatus in the space with an electronic computing device, as a function of the captured marking.

12. The method according to claim 11, wherein
at least one barcode is arranged in the area of the travel path is captured by the optical capture device of the transport apparatus as the at least one marking.

13. The method according to claim 11, wherein
the marking is captured by the optical capture device, while the transport apparatus travels through the conveyor system.

14. The method according to claim 11, wherein the multidimensional position of the transport apparatus in the space is ascertained by the electronic computing device as a function of a multidimensional reference position, assigned to a reference point (b_{A}) of the travel path, of the reference point (b_{A}) in the space.

15. The method according to claim 11, wherein a distance coverable by the transport apparatus on the travel path between the captured marking and a reference point (b_{A}) is ascertained by the electronic computing device as a function of the captured marking, as a function of which distance the multidimensional position of the transport apparatus in the space is ascertained by the electronic computing device.

16. The method according to claim 11, wherein a rotational position of the transport apparatus in the space is ascertained by the electronic computing device as a function of the captured marking.

17. The method according to claim 11, wherein at least one variable characterizing the marking is captured by the optical capture device, which variable is transferred by a second electronic computing device separately from the electronic computing device, by OPC unified architecture to the electronic computing device.

18. A conveyor system for transporting at least one component, comprising:
an optical capture device;
at least one transport apparatus that is configured to convey the at least one component through the conveyor system, the conveyor system having a travel path, along which a route section of the conveyor system is traveled by the transport apparatus; and
an electronic computing device, wherein
at least one marking is arranged in the area of the travel path, which capturable by the optical capture device of the transport apparatus, and
a multidimensional position of the transport apparatus in the space is ascertainable by the electronic computing device as a function of the captured marking.

19. The conveyor system according to claim 18, wherein
the transport apparatus is configured as a rail-bound transport apparatus.

20. The conveyor system according to claim 19, wherein
the conveyor system has at least one rail, on which the conveyor system is traveled by the transport apparatus, and
the at least one marking is arranged on a surface of the rail.
